(19) United States
(12) Patent Application Publication
(10) Pub. No.: US 2025/0290531 A1
(43) Pub. Date: Sep. 18, 2025

(54) Hybrid Compensation Nut

(71) Applicant: Illinois Tool Works Inc., Glenview, IL (US)

(72) Inventor: Mark A. Beyer, Armada, MI (US)

(21) Appl. No.: 19/071,006

(22) Filed: Mar. 5, 2025

Related U.S. Application Data
(60) Provisional application No. 63/566,465, filed on Mar. 18, 2024.

(51) Int. Cl. F16B 5/02

(52) U.S. Cl. CPC F16B 5/0266

(57) ABSTRACT

Disclosed is a fastening system for coupling a first component and a second component via a hybrid compensating assembly. The fastening system includes a male fastener, a spring clip, a threaded insert, a retainer, a threaded collar, and a female fastener. The retainer is plastic, while the remainder of the components are fabricated from metal. The spring clip defines a passageway to receive at least a portion of the male fastener. The threaded insert has a flange defining one or more notches and a threaded body with a sleeve through-hole to receive the spring clip. The retainer has a cylindrical body defining a retainer passageway and is to couple with the first component via one or more legs. The cylindrical body comprises one or more retention arms to engage the notches. The threaded collar defines an internally-threaded section and a collar flange, and it threadedly engages the threaded insert through the retainer passageway via the threaded body and the internally-threaded collar. The collar flange comprises one or more tabs extending radially outward, to secure the threaded collar to the retainer.

### RELATED APPLICATION

The present application claims priority to U.S. Provisional Patent Application No. 63/566,465, filed Mar. 18, 2024, and entitled “Hybrid Compensation Nut,” which is hereby incorporated by reference in its entirety.

### BACKGROUND

Automotive components require fastening techniques that are simple to manufacture and assemble. Further, fastening techniques should above all be reliable and efficient. Spring clips are sometimes used to compensate for tolerances between components, as well as the device itself for managing such tolerances. For example, tolerance compensation devices can comprise a base element that can be mounted onto one component and a compensation element threadedly engaged with the base element.

Therefore, despite advancements to date, it would be highly desirable to have a hybrid fastener assembly that employs a combination of different material (e.g., plastic and metal). For example, attaching the metal elements of the compensation clip with a modular plastic housing to allow for adaptation of common metal elements to be attached in different environments.

### SUMMARY

The present disclosure relates generally to a hybrid fastener assembly, substantially as illustrated by and described in connection with at least one of the figures, as set forth more completely in the claims. More particularly, to a hybrid fastener assembly.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a side elevation assembly view of a fastener-retaining system having a hybrid fastener assembly with a spring clip, in accordance with an aspect of this disclosure.

FIG. 1b illustrates a partially assembled isometric view of the fastener-retaining system.

FIG. 1c illustrates an assembled isometric view of the fastener-retaining system.

FIG. 1d illustrates a side elevation assembled view of the hybrid fastener assembly.

FIG. 1e illustrates a cross-sectional side assembled view of the hybrid fastener assembly, taken along cutline A-A in FIG. 1c.

FIG. 1f illustrates a perspective assembly view of the fastener-retaining system.

FIG. 1g illustrates a perspective assembly view of the fastener-retaining system, taken along cutline A-A in FIG. 1c.

FIG. 2a illustrates an assembled isometric view of the hybrid fastener assembly.

FIGS. 2b and 2c illustrate, respectively, top and bottom plan views of the hybrid fastener assembly.

FIGS. 2d and 2e illustrate, respectively, first and second cross-sectional assembled views of the hybrid fastener assembly, taken along cutlines B-B and C-C in FIG. 1b.

FIGS. 2f and 2g illustrate, respectively, third and fourth cross-sectional assembled views of the hybrid fastener assembly, taken along cutlines D-D and E-E in FIG. 1c.

FIG. 3a illustrates a perspective assembly view of the hybrid fastener assembly.

FIGS. 3b and 3c illustrate, respectively, first and second side elevation views of the hybrid fastener assembly.

FIGS. 3d and 3e illustrate, respectively, top and bottom plan views of a dissembled hybrid fastener assembly.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a multi-component hybrid compensating assembly configured to couple a first component relative to a second component via a fastener. The hybrid compensating assembly can use a combination of metal and non-metal components (e.g. plastic).

In one example, a fastening system for coupling a first component and a second component via a hybrid compensating assembly comprises: a male fastener; a spring clip defining a passageway configured to receive at least a portion of the male fastener; a threaded insert having a flange defining one or more notches and a threaded body defining a sleeve through-hole configured to receive the spring clip; a retainer having a cylindrical body defining a retainer passageway and configured to couple with the first component via one or more legs, wherein the cylindrical body comprises one or more retention arms configured to engage the notches; a threaded collar having an internally-threaded collar and a collar flange and configured to threadedly engage the threaded insert through the retainer passageway via the threaded body and the internally-threaded collar, and wherein the collar flange comprises one or more tabs extending radially therefrom configured to secure the threaded collar to the retainer; and a female fastener configured to threadedly engage the male fastener.

In another example, a hybrid compensating assembly for coupling a first component and a second component comprises: a retainer defining a retainer passageway and configured to couple with the first component via one or more legs, a threaded insert having a threaded body defining a sleeve through-hole; a threaded collar having an internally-threaded collar and a collar flange, wherein the threaded collar configured to threadedly engage the threaded insert via the internally-threaded collar, and wherein the collar flange comprises one or more tabs extending radially therefrom.

In yet another example, a hybrid compensating assembly for coupling a first component and a second component comprises: a threaded insert having a flange defining one or more notches and a threaded body defining a sleeve through-hole; a retainer having a cylindrical body defining a retainer passageway and configured to couple with the first component via one or more legs, wherein the cylindrical body comprises one or more retention arms configured to engage the notches; a threaded collar having an internally-threaded collar and a collar flange and configured to threadedly engage the threaded insert through the retainer passageway via the threaded body and the internally-threaded collar.

In some examples, the one or more tabs are configured to secure the threaded collar relative to the retainer.

In some examples, the one or more tabs are configured to secure the threaded collar relative to the retainer via a rotational movement or snap fitting.

In some examples, the one or more tabs are parallel to and offset relative to a plane in which the collar flange resides.

In some examples, the threaded collar defines one or more pockets configured to engage the one or more tabs via a rotational movement or snap fitting.

In some examples, each of the one or more legs comprises spring tab to lock the retainer relative to the first component.

In some examples, each of the one or more retention arms is positioned in a recessed pocket formed in the cylindrical body.

In some examples, each of the one or more retention arms includes flexible arm portion, a base portion, and a ledge portion.

In some examples, the base portion is resiliently coupled with a floor portion of a recessed pocket formed in the cylindrical body.

In some examples, the flexible arm portion extends from the base portion at an angle that is between 30 and 60 degrees relative to the floor portion.

In some examples, each of the one or more legs comprises spring tab to lock the retainer relative to the first component.

In some examples, the retainer is fabricated from a plastic material.

In some examples, the threaded insert and the threaded collar are fabricated from a metal material.

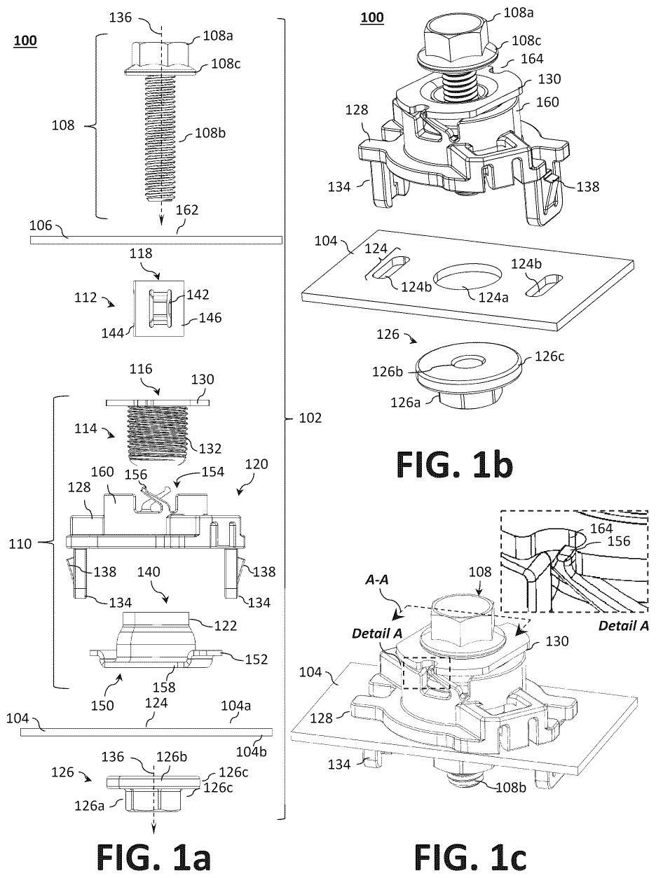

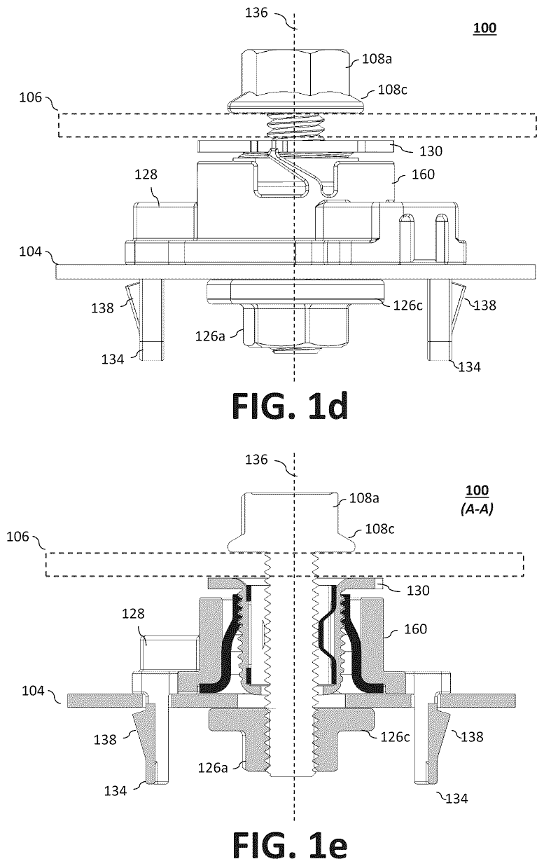

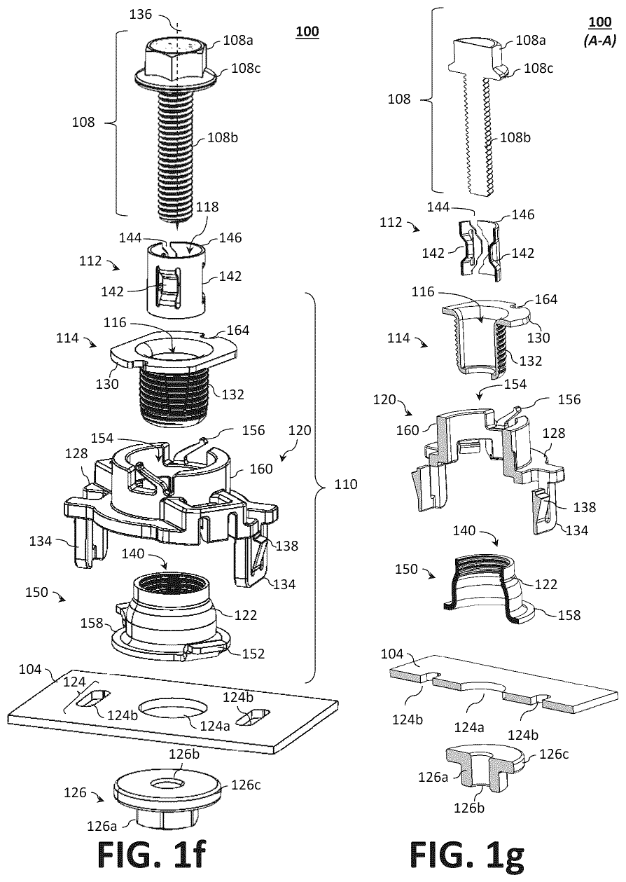

FIGS. 1a through 1g illustrate a fastener-retaining system 100 in accordance with an aspect of this disclosure having a fastener assembly 102 configured to couple a first component 104 relative to a second component 106 via a fastener 108 and a hybrid compensating assembly 110 having a spring clip 112. The second component 106 is omitted from certain views for illustrative purposes, but a non-limiting example is illustrated in FIGS. 1a, 1d, and 1e. More specifically, FIG. 1a illustrates a side elevation assembly view of a fastener-retaining system 100 having a hybrid fastener assembly 110, in accordance with an aspect of this disclosure. FIG. 1b illustrates a partially assembled isometric view of the fastener-retaining system 100. FIG. 1c illustrates an assembled isometric view of the fastener-retaining system 100. 2 FIG. 1d illustrates a side elevation assembled view of the hybrid fastener assembly 110. FIG. 1e illustrates a cross-sectional side assembled view of the hybrid fastener assembly 110, taken along cutline A-A in FIG. 1c. FIG. 1c provides additional details in the enlargement at Detail A. FIG. 1f illustrates a perspective assembly view of the fastener-retaining system 100. FIG. 1g illustrates a perspective assembly view of the fastener-retaining system 100, taken along cutline A-A in FIG. 1c.

The illustrated fastener-retaining system 100 includes a first component 104, a second component 106, and a fastener assembly 102. The fastener assembly 102 is configured to join the first component 104 and the second component 106, while compensating for tolerances. In this example, the fastener assembly 102 generally comprises a fastener 108, a spring clip 112, and a hybrid compensating assembly 110. The fastener assembly 102 can be used with, for example, the first component 104 in the form of a panel or sheet of metal having one or more openings 124 (or cutout) (e.g., a center hole 124a and clip leg openings 124b) to receive and secure with the hybrid compensating assembly 110, and a second component 106 having an opening 162 to receive the fastener 108 (e.g., a round hole). The disclosed fastener assembly 102 provides a robust connection between the first component 104 and second component 106.

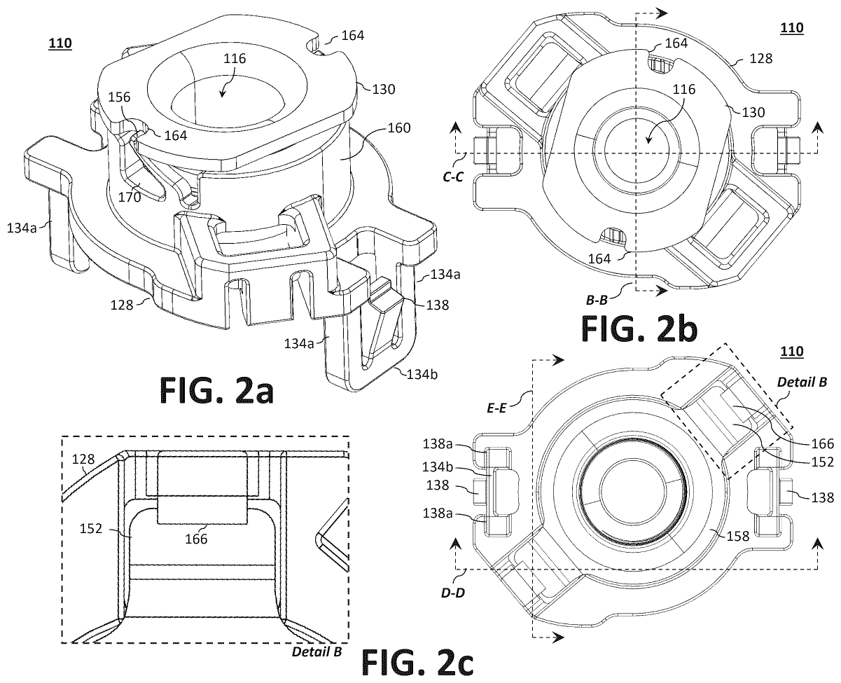

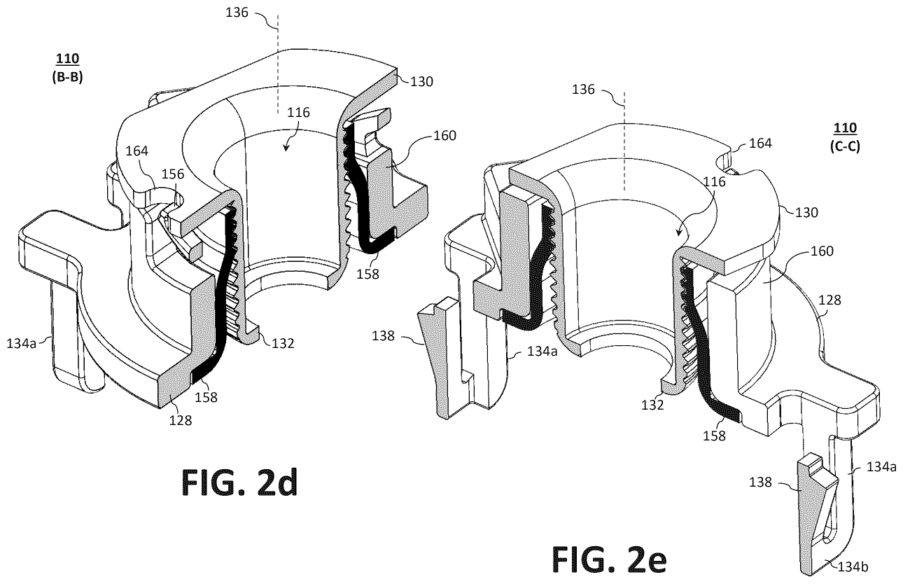

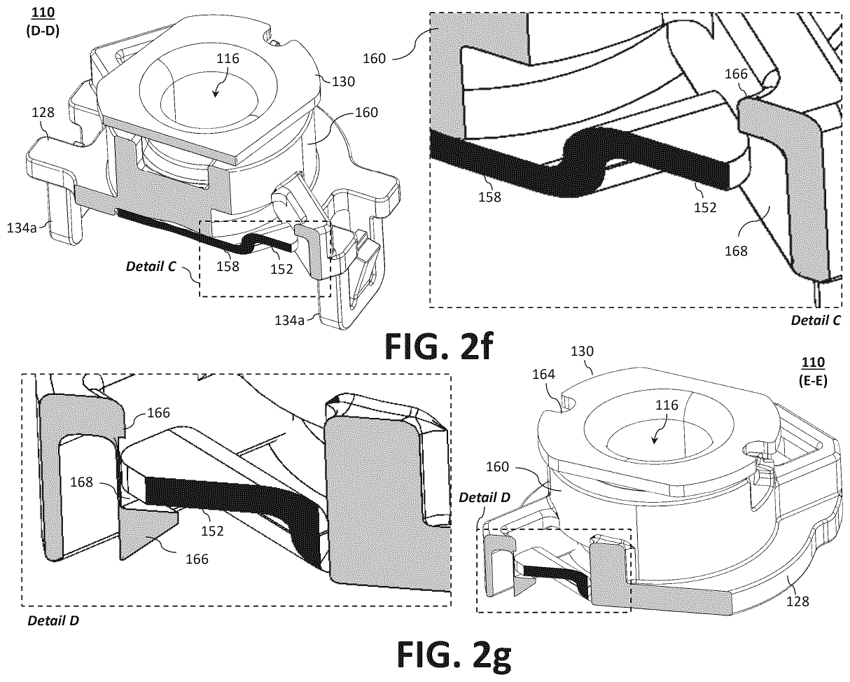

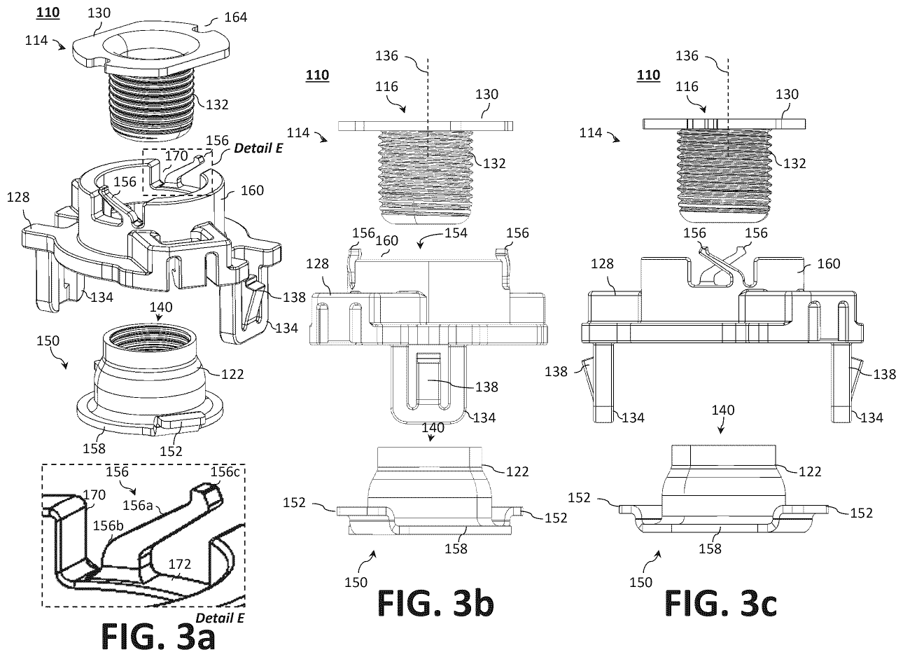

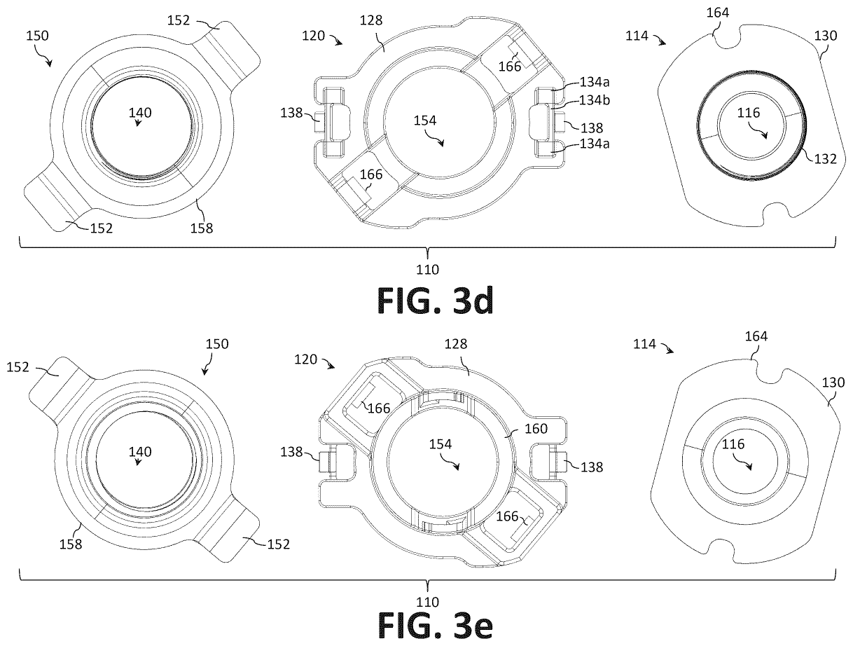

FIGS. 2a through 2g illustrate the hybrid fastener assembly 110 without the spring clip 112. FIG. 2a illustrates an assembled isometric view of the hybrid fastener assembly 110. FIGS. 2b and 2c illustrate, respectively, top and bottom plan views of the hybrid fastener assembly 110. FIG. 2c provides additional details in the enlargement at Detail B. FIGS. 2d and 2e illustrate, respectively, first and second cross-sectional assembled views of the hybrid fastener assembly 110, taken along cutlines B-B and C-C in FIG. 1b. FIGS. 2f and 2g illustrate, respectively, third and fourth cross-sectional assembled views of the hybrid fastener assembly 110, taken along cutlines D-D and E-E in FIG. 1c. FIGS. 2f and 2g provide additional details in the enlargements at Detail C and Detail D. FIG. 3a illustrates a perspective assembly view of the hybrid fastener assembly 110. FIG. 3a provides additional details in the enlargement at Detail E FIGS. 3b and 3c illustrate, respectively, first and second side elevation views of the hybrid fastener assembly 110. FIGS. 3d and 3e illustrate, respectively, top and bottom plan views of a dissembled hybrid fastener assembly 110.

The fastener 108 is illustrated as a male fastener (e.g., a head 108a connected to a collar 108c with an externally-threaded shank 108b) that is configured to engage a female fastener (e.g., an internally-threaded component, such as a threaded collar, threaded opening, a nut 126, etc.). The fastener 108 may be a bolt, for example. At least a portion of the shank 108b is externally threaded. The shank 108b is coaxial with the head 108a and the collar 108c. In the illustrated example, the male fastener 108 is a threaded bolt with a hex-shaped head, but other types of fasteners and fastener heads are contemplated. The shank 108b of the fastener 108 passes through the hybrid compensating assembly 110 (e.g., via a passageway 118 of the spring clip 112). While a bolt is illustrated, a stud (or similar component) can be used in lieu of the bolt. In this example, the nut 126 is a flanged nut having a nut body 126a (e.g., a hex-shaped body), a threaded hole 126b, and a nut flange 126c,

The hybrid compensating assembly 110 is illustrated as a multi-component retainer clip assembly comprising a retainer 120, a threaded insert 114, and a threaded collar 150. When assembled, the threaded insert 114 and the threaded collar 150 are configured to engage one another with the retainer 120 sandwiched therebetween. The threaded insert 114 and the threaded collar 150 can be rotated relative to one another about a central longitudinal axis 136 to adjust the distance between the first component 104 and second component 106 once assembled. Each of the threaded insert 114 and the threaded collar 150 can be fabricated as a stamped-metal component, for example, while the retainer 120 can be formed from a plastic material, for example.

Attaching the metal components of the hybrid compensating assembly 110 with a modular plastic retainer 120 allows for adaptation of more common metal elements to be attached in different environments. That is, the metal components are effectively isolated from the first component 104 via the retainer 120, obviating the need for additional manufacturing steps, such as over-molding.

The threaded insert 114 generally comprises a flange 130 and a threaded body 132. The flange 130 is generally annular, while the threaded body 132 is a tubular shaft with external threads formed thereon with an interior sleeve through-hole 116 therethrough. As illustrated, the flange 130 is generally planar and comprises one or more notches 164 at its perimeter. The one or more notches 164 can be punched into the flange 130 via a metal-stamping process, for example. In the illustrated example, the flange 130 comprises two notches 164 positioned on opposite sides of the flange 130 (i.e., distributed 180 degrees about the central longitudinal axis 136); however, additional or fewer notches 164 can be used. Further, the notches 164 can be evenly distributed as illustrated, or asymmetrically distributed.

The threaded collar 150 generally comprises a collar flange 158 and a threaded collar 122 that defines a threaded passageway 140 therethrough, which is configured to threadedly engage the threaded insert 114. The collar flange 158 is generally annular with one or more radially protruding tabs 152, while the threaded collar 122 is a tubular shaft with internal threads. The tabs 152 can be bent relative to the collar flange 158 such that they are parallel to, but offset, relative to the generally planar collar flange 158. The threaded collar 150 is configured to receive and threadedly engages the threaded insert 114 via the threaded passageway. As will be discussed, one or more radially protruding tabs 152 are configured to rotatable engage and lock relative to the retainer 120 via one or more pockets 168 formed in the retainer 120. The internally-threaded collar 122 can be formed in or on the collar flange 158 (e.g., via cold forming).

The illustrated retainer 120 is formed as a base 128 having a cylindrical body 160 extending perpendicular to the base 128, where a retainer passageway 154 formed through the cylindrical body 160. The cylindrical body 160 comprises one or more retention arms 156 formed in the sidewall of the cylindrical body 160 that, as will be discussed, are configured to engage the notches 164. The one or more retention arms 156 can be spaced or otherwise arranged about the perimeter of the cylindrical body 160 to correspond to the locations of the notches 164 formed in or on the flange 130. The protruding tabs 152 on the threaded collar 150 for it to be snapped into the plastic retainer 120 via a snap fitting. The curved, retention arm 156 on the retainer 120 to retain the compensating nut in position during transit and handling. The curved, retention arm 156 is resilient coupled to the cylindrical body 160 in a recessed pocket 170 formed therein to protect the retention arm 156 during shipping and handling. The longer curved profile of the retention arm 156 allows for tunable and repeatable retention efforts.

With reference to Detail C of FIG. 3a, for example, each retention arm 156 can comprise a flexible arm portion 156a, a base portion 156b, and a ledge portion 156c. The illustrated base portion 156b is positioned within the recessed pocket 170 and coupled to a floor portion 172 thereof. The flexible arm portion 156a extends from the base portion 156b at an angle (e.g., 30-60 degrees, or about 45 degrees, relative to the floor portion 172 of the recessed pocket 170. The ledge portion 156c is configured to hook onto the flange 130 via a notch 164 to mitigate unwanted rotation of the flange 130 relative to the retainer 120 and, when fixedly coupled to the threaded collar 150, the threaded collar 150. The flange 130 can be configured as a hook or protrusion.

The threaded collar 150 is configured to attach to the retainer 120 via one or more protruding tabs 152, which snap into or otherwise couple with the plastic retainer 120. Thus, the snap-type retention snap 166 (e.g., a resiliently attached hook, as illustrated) on the retainer 120 defines the pockets 168, which secures the threaded collar 150, thus allowing for simple assembly of the metal to plastic, obviating the need for over-molding. For example, with reference to the detailed views of FIGS. 2f and 2g, tabs 152 are configured to slide into one or more pockets 168 formed in the retainer 120 via, for example, a retention snap 166 on the retainer 120. The threaded collar 150 can attach to the retainer 120 via a push and snap movement (e.g., a push and snap movement) or a quarter-turn movement (e.g., a push and turn movement, such as 90-degree rotation), though other snap and rotational movements are contemplated depending on the number and location of the tabs 152 and pockets 168. For example, a threaded collar 150 with four tabs 152 could engage via an eighth-turn movement (i.e., a 45-degree rotation).

The base 128 comprises a pair of legs 134 resiliently coupled thereto that are generally perpendicular to the base 128. Each of the legs 134 comprises one or more attachment features, such as the illustrated spring tabs 138. For example, as best illustrated in FIG. 2a, each leg 134 can be composed of a pair of vertical post portions 134a joined at their free ends via a horizontal bridge portion 134b. In the illustrated example, the spring tabs 138 are positioned between (and parallel to) the vertical post portions 134a and resiliently coupled to the horizontal bridge portion 134b. The retainer 120 can be fabricated as a single component as, for example, an injection-molded component.

The spring clip 112 is configured to be retained within the interior sleeve through-hole 116 formed by the threaded insert 114, while the fastener 108 resides within a passageway 118 of the spring clip 112. The fastener 108 can be pre-captured into the hybrid compensating assembly 110 with the spring clip 112 through friction via the spring clip 112 when positioned in the sleeve through-hole 116 of the threaded insert 114. In practice, the fastener assembly 102 can be provided as a pre-assembly that is then installed into the first component 104 for pre-capturing.

To facilitate attachment via the fastener assembly 102, both the first component 104 and the second component 106 can include one or more engagement features. For example, the first component 104 and the second component 106 each comprise openings 124, 162 formed therein. Specifically, the first component 104 defines multiple openings 124, illustrated as a round center hole 124a to receive the fastener 108 and two clip leg openings 124b to receive and engage the legs 134 (e.g., via the spring tabs 138). Similarly, the second component 106 defines a round opening 162 to receive the fastener 108. The round opening 162 and the round center hole 124a can be the same size and shape, as illustrated.

The openings 124, 162 can be formed in the first component 104 and/or the second component 106 during manufacturing or added post-manufacture through a mechanical process (e.g., drilling, cutting, carving, etc.). The opening 124 formed in the first component 104 extends between and through opposite surfaces 104a and 104b (such as a top surface and a bottom surface) of the first component 104. In some examples, the round center hole 124a can be threaded. For example, the round center hole 124a can be threaded and configured to engage the fastener 108.

The fastener 108 is configured to pass through the openings 124, 162 and the hybrid compensating assembly 110 to mechanically engage and couple with the second component 106 and/or a nut 126. The male fastener 108 can be rotated relative to the nut 126 about its axis of rotation (e.g., the central longitudinal axis 136) to join and compress the first component 104 and the second component 106 relative to one another.

The threaded insert 114 can be rotated relative to the threaded collar 150 about its axis of rotation (e.g., the central longitudinal axis 136) to adjust the height of the hybrid compensating assembly 110, thus increasing the (or decreasing) the distance between the first component 104 and second component 106. When assembled, the hybrid compensating assembly 110 is compressively trapped between the upper surface 104a of the first component 104 and a portion of the fastener 108, such as the lower surface of the collar 108c.

As noted, certain components of the fastener assembly 102 may be fabricated from a metal material using metal tubes and/or metal sheets via metal-drawing, metal-stamping, or other metal-forming techniques. For example, the spring clip 112, the threaded insert 114, and the threaded collar 150 can be formed through a metal-stamping process. Other components of the hybrid compensating assembly 110, such as the retainer 120, may be fabricated from plastic materials using plastic injection molding, additive manufacturing, or similar techniques. While the threaded insert 114 and the threaded collar 150 are described as each being a metal material, it is contemplated that the threaded insert 114 could be a plastic material, while the threaded collar 150 is a metal material. It is also contemplated that components of the fastener assembly 102 could be fabricated using material extrusion (e.g., fused deposition modeling (FDM), stereolithography (SLA), selective laser sintering (SLS), material jetting, binder jetting, powder bed fusion, directed energy deposition, VAT photopolymerization, or other suitable additive manufacturing/3D printing processes).

The first component 104 and the second component 106 may be, for example, automotive panels or other automotive components. Depending on the application, one or both components may be fabricated from metal (or a metal alloy), synthetic or semi-synthetic polymers (e.g., acrylonitrile butadiene styrene (ABS), polyvinyl chloride (PVC), etc.), composite materials (e.g., fiberglass), or a combination thereof. In the automotive industry, example first components 104 include, without limitation, door trim panels, moldings, trim pieces, and other substrates (whether used as interior or exterior surfaces). The second component 106 may be a frame, an automotive panel, or a structural vehicle component, such as doors, pillars (e.g., A-pillar, B-pillar, C-pillar), dashboard components (e.g., cross members, brackets, frames), seat frames, center consoles, fenders, or sheet metal frameworks.

After the first component 104 and the second component 106 are assembled, as illustrated in FIGS. 1d and 1e, the first component 104 can be partially or fully covered by the second component 106. In some examples, one or both components can include additional attachment features. The fastener assembly 102 may also comprise a seal to mitigate dust, dirt, and/or moisture penetration through the openings 124. The seal may be embodied as a ring (e.g., an annulus) fabricated from foam, thermoplastic, rubber, or similar materials. For example, a seal can be configured to surround a portion of the male fastener 108 (e.g., the shank 108b) and positioned between the head 108a and the second component 106 and/or the flange 130 and the second component 106.

While the figures illustrate the fastener-retaining system 100 as being coupled to the second component 106 via a nut 126, other fastening techniques and arrangements are contemplated. For example, instead of a threaded nut 126, a friction-based fastener could be used (e.g., a clip, sleeve, etc.).

The spring clip 112 generally comprises a cylindrical sidewall 146 that is coaxial with the central longitudinal axis 136. The spring clip 112 defines various engagement features formed in or on the cylindrical sidewall 146. For example, the illustrated spring clip 112 includes a plurality of spring tabs 142, each positioned within and coupled to a window 148 of the cylindrical sidewall 146. During the stamping process, the metal plate can be stamped to form the window 148 and the outer profile/shape of the spring tabs 142. Each spring tab 142 can therefore be resiliently coupled at an edge of a window 148 in a cantilevered fashion, which is then bent inwardly toward the central longitudinal axis 136. The cylindrical sidewall 146 further comprises a slot 144 that allows the cylindrical sidewall 146 to flex (e.g., move toward or away from the central longitudinal axis 136) during, for example, installation.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A fastening system for coupling a first component and a second component via a hybrid compensating assembly, the fastening system comprising:
a male fastener;
a spring clip defining a passageway configured to receive at least a portion of the male fastener;
a threaded insert having a flange defining one or more notches and a threaded body defining a sleeve through-hole configured to receive the spring clip;
a retainer having a cylindrical body defining a retainer passageway and configured to couple with the first component via one or more legs,
wherein the cylindrical body comprises one or more retention arms configured to engage the notches;
a threaded collar having an internally-threaded collar and a collar flange and configured to threadedly engage the threaded insert through the retainer passageway via the threaded body and the internally-threaded collar, and
wherein the collar flange comprises one or more tabs extending radially therefrom configured to secure the threaded collar to the retainer; and
a female fastener configured to threadedly engage the male fastener.

2. The fastening system of claim 1, wherein each of the one or more legs comprises spring tab to lock the retainer relative to the first component.

3. The fastening system of claim 1, wherein the retainer is fabricated from a plastic material.

4. The fastening system of claim 1, wherein the threaded insert and the threaded collar are fabricated from a metal material.

5. A hybrid compensating assembly for coupling a first component and a second component comprising:
a retainer defining a retainer passageway and configured to couple with the first component via one or more legs,
a threaded insert having a threaded body defining a sleeve through-hole;
a threaded collar having an internally-threaded collar and a collar flange,
wherein the threaded collar configured to threadedly engage the threaded insert via the internally-threaded collar, and
wherein the collar flange comprises one or more tabs extending radially therefrom.

6. The hybrid compensating assembly of claim 5, wherein the one or more tabs are configured to secure the threaded collar relative to the retainer.

7. The hybrid compensating assembly of claim 5, wherein the one or more tabs are configured to secure the threaded collar relative to the retainer via a snap fitting or a rotational movement.

8. The hybrid compensating assembly of claim 5, wherein the one or more tabs are parallel to and offset relative to a plane in which the collar flange resides.

9. The hybrid compensating assembly of claim 5, wherein the threaded collar defines one or more pockets and retention snap configured to engage the one or more tabs.

10. The hybrid compensating assembly of claim 5, wherein each of the one or more legs comprises spring tab to lock the retainer relative to the first component via a retention snap or rotational movement.

11. The hybrid compensating assembly of claim 5, wherein the retainer is fabricated from a plastic material.

12. The hybrid compensating assembly of claim 5, wherein the threaded insert and the threaded collar are fabricated from a metal material.

13. A hybrid compensating assembly for coupling a first component and a second component comprising:
a threaded insert having a flange defining one or more notches and a threaded body defining a sleeve through-hole;
a retainer having a cylindrical body defining a retainer passageway and configured to couple with the first component via one or more legs,
wherein the cylindrical body comprises one or more retention arms configured to engage the notches;
a threaded collar having an internally-threaded collar and a collar flange and configured to threadedly engage the threaded insert through the retainer passageway via the threaded body and the internally-threaded collar.

14. The hybrid compensating assembly of claim 13, wherein each of the one or more retention arms is positioned in a recessed pocket formed in the cylindrical body.

15. The hybrid compensating assembly of claim 13, wherein each of the one or more retention arms includes flexible arm portion, a base portion, and a ledge portion.

16. The hybrid compensating assembly of claim 15, wherein the base portion is resiliently coupled with a floor portion of a recessed pocket formed in the cylindrical body.

17. The hybrid compensating assembly of claim 16, wherein the flexible arm portion extends from the base portion at an angle that is between 30 and 60 degrees relative to the floor portion.

18. The hybrid compensating assembly of claim 13, wherein each of the one or more legs comprises spring tab to lock the retainer relative to the first component.

19. The hybrid compensating assembly of claim 13, wherein the retainer is fabricated from a plastic material.

20. The hybrid compensating assembly of claim 13, wherein the threaded insert and the threaded collar are fabricated from a metal material.
